(19) United States
(12) Patent Application Publication
(10) Pub. No.: US 2025/0174171 A1
(43) Pub. Date: May 29, 2025

(54) DATA STORAGE CIRCUIT, SILICON-BASED DISPLAY PANEL AND DISPLAY DEVICE

(71) Applicant: SeeYa Optronics, Co., Ltd., Shanghai (CN)

(72) Inventors: Ping-Lin Liu; Haodong Zhang, Shanghai (CN)

(73) Assignee: SeeYa Optronics Co., Ltd., Shanghai (CN)

(21) Appl. No.: 18/872,270

(22) PCT Filed: Nov. 30, 2023
(86) PCT No.: PCT/CN2023/135433

§ 371 Date: Dec. 5, 2024

(30) Foreign Application Priority Data
Nov. 7, 2023 (CN) 202311474484.9

(51) Int. Cl. G09G 3/20

(52) U.S. Cl. CPC G09G 3/2092; G09G 2300/0819; G09G 2300/0861; G09G 2310/0275; G09G 2310/08; G09G 2320/0233; G09G 2330/021

(57) ABSTRACT

A data storage circuit includes at least one data storage sub-module. The data storage sub-module includes a first switch, a second switch, a third switch, a capacitor unit and a first operational amplifier. One end of the first switch is electrically connected to an input terminal of the data storage circuit, and the other end of the first switch is electrically connected to the capacitor unit at a first node. The capacitor unit is also electrically connected to a first input terminal of the first operational amplifier at a second node, and an output terminal of the first operational amplifier is electrically connected to a third node. The second switch is electrically connected between the first node and the third node, and the third switch is electrically connected between the second node and the third node.

The present application claims priority to Chinese Patent Application No. 202311474484.9, filed with the China National Intellectual Property Administration (CNIPA) on Nov. 7, 2023, the disclosure of which is incorporated herein by reference in its entirety.

### TECHNICAL FIELD

The present application relates to the field of display technologies, for example, a data storage circuit, a silicon-based display panel, and a display device.

### BACKGROUND

With the rapid development of display technologies, display requirements of a display panel is becoming increasingly high, and in particular, requirements for display quality of the display panel is becoming increasingly high.

In the related display panel, sub-pixels in the display panel are generally arranged in an array and are loaded with data signals line by line to achieve the display. In the process of writing the data signals into the sub-pixels by the data driver chip, the data signals are stored by a data storage circuit to improve the charging rate. However, if the stability of the data storage circuit is poor, then the data signals written into the sub-pixels will change, thereby affecting the display quality of the display panel.

### SUMMARY

The present application provides a data storage circuit, a silicon-based display panel and a display device, to improve the stability of a data signal output by the data storage circuit, thereby ensuring the display uniformity of the silicon-based display panel using the data storage circuit and improving the display effect.

In a first aspect, an embodiment of the present application provides a data storage circuit. The data storage circuit includes at least one data storage sub-module. The data storage sub-module includes a first switch, a second switch, a third switch, a capacitor unit and a first operational amplifier. One end of the first switch is electrically connected to an input terminal of the data storage circuit, and the other end of the first switch is electrically connected to the capacitor unit at a first node. The capacitor unit is also electrically connected to a first input terminal of the first operational amplifier at a second node, and an output terminal of the first operational amplifier is electrically connected to a third node. The second switch is electrically connected between the first node and the third node, and the third switch is electrically connected between the second node and the third node.

In a second aspect, an embodiment of the present application provides a silicon-based display panel. The silicon-based display panel includes a silicon-based substrate, multiple sub-pixels arranged in an array and disposed on the silicon-based substrate, and multiple data lines. At least part of sub-pixels among the multiple sub-pixels in a same column are electrically connected to a same data line among the multiple data lines. The silicon-based display panel further includes a data drive module, a data storage module, and a data write module which are disposed on the silicon-based substrate. The data drive module is configured to provide data signals corresponding to the multiple data lines. The data storage module is configured to store the data signals and control the data signals to be transmitted to the data write module. The data write module is configured to control the data signals to be written into the multiple data lines. The data storage module includes two data storage sub-modules, the two data storage sub-modules are respectively a first data storage sub-module and a second data storage sub-module, each of the first data storage sub-module and the second data storage sub-module includes a first switch, a second switch, a third switch, a capacitor unit and a first operational amplifier, one end of the first switch is electrically connected to an input terminal of the data storage module, the other end of the first switch is electrically connected to a first terminal of the capacitor unit at a first node, a second terminal of the capacitor unit is electrically connected to a first input terminal of the first operational amplifier at a second node, an output terminal of the first operational amplifier is electrically connected to a third node, the second switch is electrically connected between the first node and the third node, and the third switch is electrically connected between the second node and the third node. In two adjacent rows of sub-pixels electrically connected to a same data line among the multiple data lines, a sub-pixel in a previous row is a sub-pixel in an n-th row, and a sub-pixel in a next row is a sub-pixel in an (n+1)-th row, where n is a positive integer; and the first data storage sub-module is configured to control a data signal of the sub-pixel in the n-th row to be transmitted to the data write module, and the second data storage sub-module is configured to control a data signal of the sub-pixel in the (n+1)-th row to be transmitted to the data write module.

In a third aspect, an embodiment of the present application provides a display device including the silicon-based display panel described in the second aspect.

### BRIEF DESCRIPTION OF DRAWINGS

FIG. 1 is a schematic structural diagram of a data storage circuit according to an embodiment;

FIG. 2 is a schematic structural diagram of a data storage circuit according to an embodiment of the present application;

FIG. 3 is a working timing diagram of a data storage sub-module according to an embodiment of the present application;

FIG. 4 is a schematic structural diagram of a silicon-based display panel according to an embodiment of the present application;

FIG. 5 is a schematic structural diagram of another silicon-based display panel according to an embodiment of the present application;

FIG. 6 is a data driving timing diagram of the silicon-based display panel shown in FIG. 5;

FIG. 7 is a schematic structural diagram of another silicon-based display panel according to an embodiment of the present application;

FIG. 8 is a data driving timing diagram of the silicon-based display panel shown in FIG. 7;

FIG. 9 is a schematic structural diagram of another silicon-based display panel according to an embodiment of the present application;

FIG. 10 is a data driving timing diagram of the silicon-based display panel shown in FIG. 9;

FIG. 11 is a schematic structural diagram of another silicon-based display panel according to an embodiment of the present application;

FIG. 12 is a data driving timing diagram of the silicon-based display panel as shown in FIG. 11; and

FIG. 13 is a schematic structural diagram of a display device according to an embodiment of the present application.

### DETAILED DESCRIPTION

The technical solutions of the present application will be described clearly and completely below in conjunction with the accompanying drawings in embodiments of the present application and the embodiments. Apparently, the described embodiments are embodiments of relevant parts of the present application.

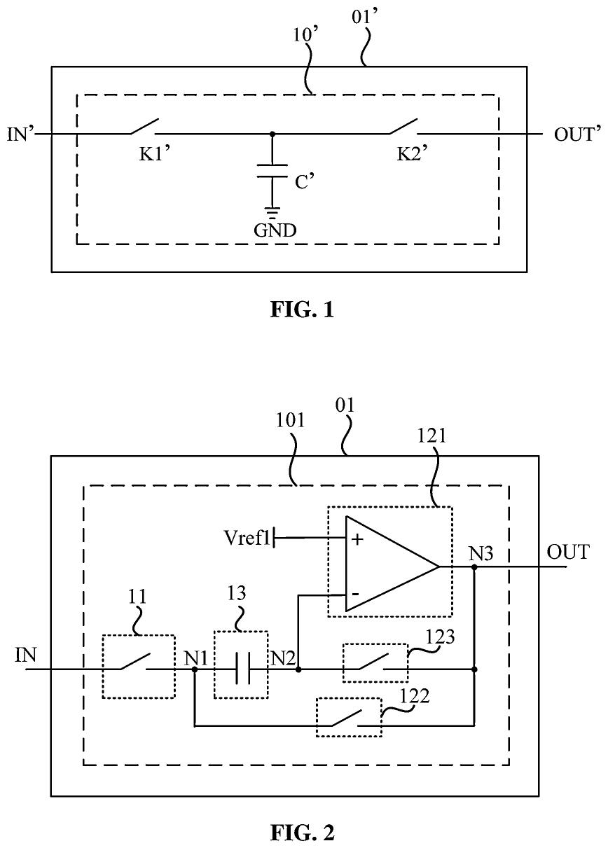

FIG. 1 is a schematic structural diagram of a data storage circuit. A data storage module 10′ of a data storage circuit 01′ includes a first switch unit K1′, a second switch unit K2′ and a storage capacitor C. An upper electrode plate of the storage capacitor C′ is coupled between the first switch unit K1′ and the second switch unit K2′, and a lower electrode plate of the storage capacitor C′ is connected to the ground. Specifically, in a case where the first switch unit K1′ is turned on, an input terminal IN′ of the data storage circuit 01′ writes a received data signal into the storage capacitor C′, and in a case where the second switch unit K2′ is turned on, the storage capacitor C′ transmits the stored data signal to an output terminal OUT′ of the data storage circuit 01′, so that the data signal can be further written into a sub-pixel in a display panel through a data line. However, since the lower electrode plate of the storage capacitor C′ is connected to the ground, the data signal stored in the storage capacitor C′ tends to fluctuate due to the influence of the ground signal GND. In addition, the data signal stored in the storage capacitor C′ may also fluctuate due to the influence of the voltage fluctuation of the output terminal OUT′ of the data storage circuit 01′, as a result, data signals finally written into multiple sub-pixels of the display panel will be different, thereby resulting in the poor display uniformity of the display panel, and reducing the display quality.

Based on this, an embodiment of the present application provides a data storage circuit. The data storage circuit includes at least one data storage sub-module. The data storage sub-module includes a first switch, a second switch, a third switch, a capacitor unit and a first operational amplifier. One end of the first switch is electrically connected to an input terminal of the data storage circuit, and the other end of the first switch is electrically connected to the capacitor unit at a first node. The capacitor unit is also electrically connected to a first input terminal of the first operational amplifier at a second node, and an output terminal of the first operational amplifier is electrically connected to a third node. The second switch is electrically connected between the first node and the third node, and the third switch is electrically connected between the second node and the third node.

By means of the data storage sub-module with the above-described structure, the data storage circuit may be controlled so that: in a first time period, the first switch and the third switch are turned on, the second switch is turned off, the data signal received by the input terminal of the data storage circuit is controlled to be written into the first node and to be stored in the capacitor unit, and a voltage of the second node is the same as a voltage of a third node; in a second time period, the first switch and the third switch are turned off, and the second switch is turned on, so that a voltage of the first node is the same as the voltage of the third node. Voltages of the first node and the second node at two terminals of the capacitor unit are relatively stable, so that a data signal finally provided to the third node remains constant, and further, the stability of the data signal outputted from the output terminal of the data storage circuit can be ensured. In this way, the display uniformity of a silicon-based display panel adopting the data storage circuit can be improved, and thus the display quality is improved.

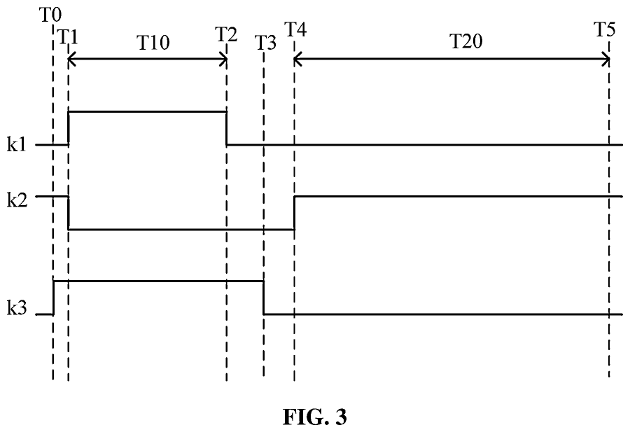

FIG. 2 is a schematic structural diagram of a data storage circuit according to an embodiment of the present application. As shown in FIG. 2, the data storage circuit 01 includes at least one data storage sub-module 101. The data storage sub-module 101 includes a first switch 11, a second switch 122, a third switch 123, a capacitor unit 13 and a first operational amplifier 121. One end of the first switch 11 is electrically connected to an input terminal IN of the data storage circuit 01, the other end of the first switch 11 is electrically connected to a first terminal of the capacitor unit 13 at a first node N1, a second terminal of the capacitor unit 13 is electrically connected to a first input terminal of the first operational amplifier 121 at a second node N2, and an output terminal of the first operational amplifier 121 is electrically connected to a third node N3. The second switch 122 is electrically connected between the first node N1 and the third node N3, and the third switch 123 is electrically connected between the second node N2 and the third node N3.

With continued reference to FIG. 2, the first switch 11 may control the turn-on or turn-off of a transmission path through which the data signal received by the input terminal IN of the data storage circuit 01 is transmitted to the capacitor unit 13. In a case where the first switch 11 is turned on, the data signal received at the input terminal IN of the data storage circuit 01 may be written into the first node N1 and stored in the capacitor unit 13. The second switch 122 controls the turned-on or turned-off between the first node N1 and the third node N3, that is, controls the electrical connection or the disconnection between the first terminal of the capacitor unit 13 and the output terminal of the first operational amplifier 121. In a case where the second switch 122 is turned on, the voltage of the first node N1 is the same as the voltage of the third node N3. The third switch 123 controls the second node N2 and the third node N3 to be turned on or off, that is, controls the second terminal of the capacitor unit 13 and the output terminal of the first operational amplifier 121 to be electrically connected or disconnected. In a case where the third switch 123 is turned on, the voltage of the second node N2 is the same as the voltage of the third node N3.

A working process of the data storage sub-module 101 includes a first time period and a second time period. In the first time period, the first switch 11 and the third switch 123 are turned on, and the second switch 122 is turned off, so that a data signal received by the input terminal IN of the data storage circuit 101 is controlled to be written into the first node N1 and to be stored in the capacitor unit 13, and the voltage of the second node N2 is the same as the voltage of the third node N3. In the second time period, the first switch 11 is turned off, the third switch 123 is turned off, and the second switch 122 is turned on, so that the voltage of the first node N1 is the same as the voltage of the third node N3.

With continued reference to FIG. 2, the first input terminal of the first operational amplifier 121 is an inverting input terminal. The first operational amplifier 121 includes a second input terminal, and the second input terminal is a non-inverting input terminal and is electrically connected to a reference voltage source Vref1. A reference voltage provided by the reference voltage source Vref1 is vref1.

In the first time period, the first switch 11 is turned on, so that the data signal received by the input terminal IN of the data storage circuit 01 is written into the first node N1 and stored in the capacitor unit 13. Moreover, the third switch 123 is also turned on, so that a short circuit is formed between the second node N2 and the third node N3, and further the voltage of the second node N2 is the same as the voltage of the third node N3, whereby a voltage of the output terminal of the first operational amplifier 121 is equal to vref1+Vos, where Vos is an unregulated voltage of the first operational amplifier 121, that is, each of the voltage of the second node N2 and the voltage of the third node N3 is vref1+Vos, in this case, the second switch 122 is turned off, and a potential of the first node N1 and a potential of the third node N3 do not influence each other. In the second time period, the first switch 11 is turned off, the second switch 122 is turned on, and the third switch 123 is turned off, so that a short circuit is formed between the first node N1 and the third node N3, and further the voltage of the first node N1 is the same as the voltage of the third node N3. The voltage of the first node N1 is a voltage of a written data signal, so that the data signal of the first node N1 is transmitted to the third node N3, that is, the voltage of the third node N3 is also the voltage of the data signal, while the voltage at the second node N2 remains unchanged, that is, vref1+Vos. In this way, the data signal stored by the capacitor unit 13 may be finally transmitted to the third node N3 stably, and will not be affected by the unregulated voltage of the first operational amplifier 121, thereby improving the stability of the data signal output by the data storage circuit 01, and improving the display uniformity and the display quality of the silicon-based display panel adopting the data storage circuit 01.

In some embodiments, an example in which a turn-on signal of the first switch 11, a turn-on signal of the second switch 122 and a turn-on signal of the third switch 123 are all at a high level, a turn-off signal of the first switch 11, a turn-off signal of the second switch 122 and a turn-off signal of the third switch 123 are all at a low level is used. FIG. 3 is a working timing diagram of a data storage sub-module according to an embodiment of the present application, As shown with combined reference to FIGS. 2 and 3, a control signal of the first switch 11 is k1, a control signal of the second switch 122 is k2, and a control signal of the third switch 123 is k3.

A time period between a T0 moment and a T1 moment is a capacitor initialization time period, the first switch 11 is turned off, and both the second switch 122 and the third switch 123 are turned on, so that the voltage of the first node N1, the voltage of the second node N2, and the voltage of the third node N3 are equal and may be the first voltage, in this case, the voltage of the output terminal of the first operational amplifier 121 is equal to vref1+Vos, that is, the first voltage is vref1+Vos, whereby the voltage of the first node N1, the voltage of the second node N2, and the voltage of the third node N3 are all equal and equal to vref1+Vos. The first terminal of the capacitor unit 13 is connected to the first node N1, and the second terminal of the capacitor unit 13 is connected to the second node N2, in this case, the first terminal and the second terminal of the capacitor unit 13 have equal potential and a potential difference of zero. The capacitor unit 13 is initialized, thereby eliminating the influence of the potential difference of the capacitor unit 13 before the T0 moment.

In a time period between the T1 moment and a T2 moment, i.e., a first time period T10, both the first switch 11 and the third switch 123 are turned on, the second switch 122 is turned off, so that the data signal received by the input terminal IN of the data storage circuit 01 is written into the first node N1 and is stored in the capacitor unit 13. Moreover, a short circuit is formed between the second node N2 and the third node N3, so that the voltage of the second node N2 and the voltage of the third node N3 are the same and are the first voltage, that is, the voltage of the output terminal of the first operational amplifier 121 is kept to be equal to vref1+Vos.

In a time period between the T2 moment and a T3 moment, both the first switch 11 and the second switch 122 are turned off, and the third switch 123 is turned on, so that the voltage of the second node N2 and the voltage of the third node N3 are maintained at the first voltage, that is, vref1+Vos, and the voltage of the first node N1 is kept to be the voltage of the data signal.

In a time period between the T3 moment and a T4 moment, the first switch 11, the second switch 122 and the third switch 123 are all turned off, so that the voltages of the two terminals of the capacitor unit 13 remain unchanged.

In a time period between the T4 moment and a T5 moment, i.e., a second time period T20, the second switch 122 is turned on, and the first switch 11 and the third switch 123 are turned off, so that a short circuit is formed between the first node N1 and the third node N3, and further the voltage of the first node N1 is the same as the voltage of the third node N3. The voltage of the first node N1 is the voltage of the written data signal, so that the data signal of the first node N1 is transmitted to the third node N3, that is, the voltage of the third node N3 is also the voltage of the data signal, and the voltage of the second node N2 remains unchanged as the first voltage vref1+Vos.

The switching of an on state and an off state of the first switch 11, the second switch 122, and the third switch 123 is controlled at different time periods, so that the data signal stored in the capacitor unit 13 may be finally transmitted to the third node N3 stably without being affected by the unregulated voltage of the first operational amplifier 121, the stability of the data signal output by the data storage circuit 01 is improved, further the data signal output by the output terminal OUT of the data storage circuit 01 can be ensured to be stable, and the stability of the data signal output by the data storage circuit 01 is improved, in this way, the display uniformity of the display panel using the data storage circuit 01 can be improved, and the display quality can be improved.

Optionally, the first operational amplifier 121 may be a transconductance first operational amplifier, and the transconductance first operational amplifier has the characteristics of good high-frequency performance, high conversion rate under large signal, simple circuit structure, and low power supply voltage and power consumption, and is easily integrated with other circuits.

Optionally, each of the first switch 11, the second switch 122 and the third switch 123 is a metal oxide field effect transistor or other elements, which is not specifically limited herein.

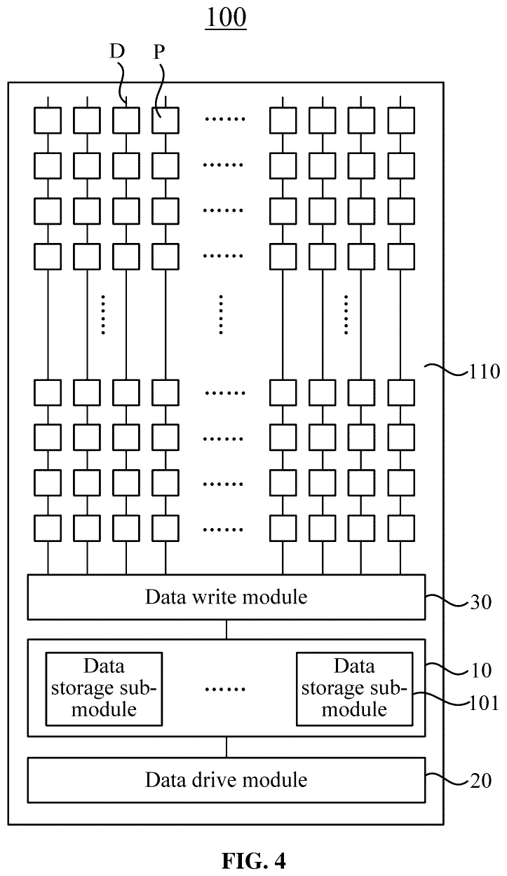

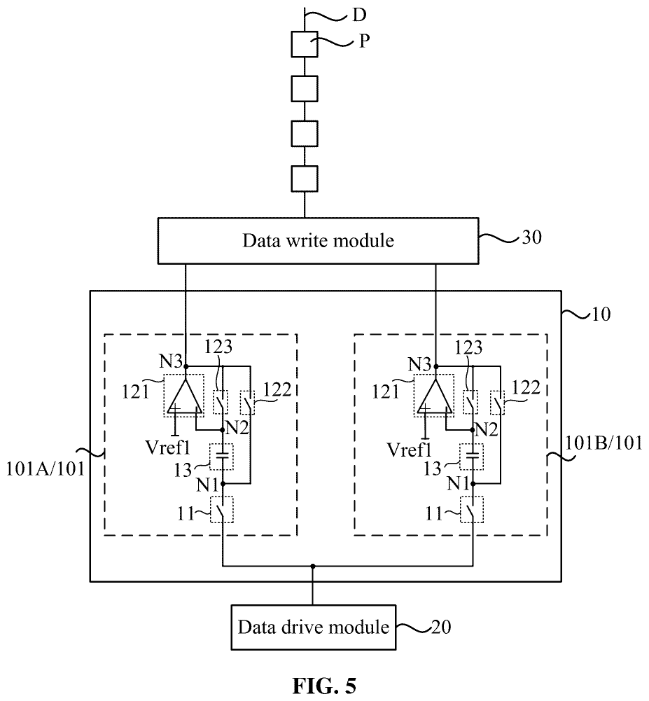

An embodiment of the present application further provides a silicon-based display panel. FIG. 4 is a schematic structural diagram of a silicon-based display panel according to an embodiment of the present application. The silicon-based display panel 100 includes a silicon-based substrate 110, multiple sub-pixels P arranged in an array and disposed on the silicon-based substrate 110, and multiple data lines D, where at least part of sub-pixels P in a same column are electrically connected to the same data line D. The silicon-based display panel 100 further includes a data drive module 20, a data storage module 10 and a data write module 30 which are disposed on the silicon-based substrate 110. The data drive module 20 is configured to provide data signals of the multiple sub-pixels P. The data storage module 10 is configured to store the data signals and control the data signals to be transmitted to the data write module 30. The data storage module 10 includes multiple data storage sub-modules 101 as described above. A data write sub-module 30 is configured to control the data signals to be written into the data line D and the multiple sub-pixels P electrically connected to the data line D.

The silicon-based display panel 100 uses a silicon base as a substrate, and both the data storage circuit 10 and the sub-pixel P are disposed on the silicon-based substrate. Optionally, the silicon-based display panel provided in this embodiment is a silicon-based liquid crystal display panel or a silicon-based organic light emitting display panel. The sub-pixel P may include a red sub-pixel, a green sub-pixel, a blue sub-pixel, and the like, which may be set according to practical requirements, and is not limited herein.

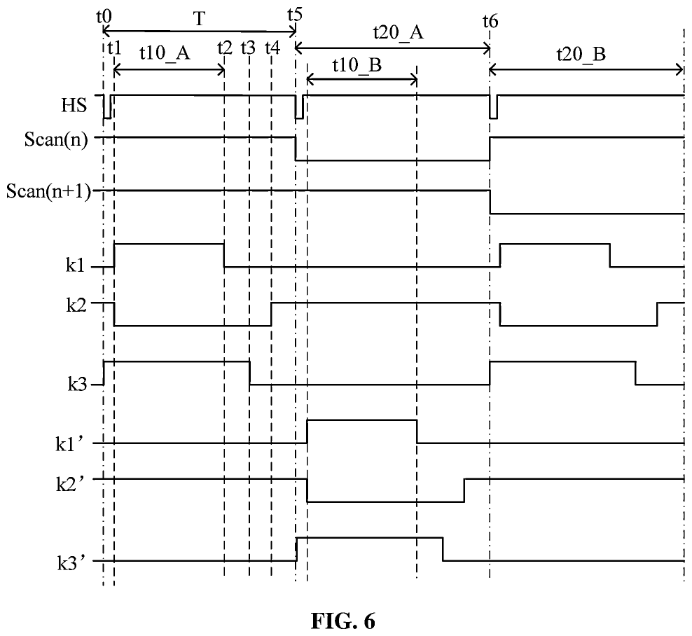

With reference to FIG. 5, FIG. 5 is a schematic structural diagram of another silicon-based display panel according to an embodiment of the present application. Specifically, the data storage module 10 includes two data storage sub-modules 101, and the two data storage sub-modules 101 are respectively a first data storage sub-module 101A and a second data storage sub-module 101B. Each of the first data storage sub-module 101A and the second data storage sub-module 101 B includes a first switch 11, a second switch 122, a third switch 123, a capacitor unit 13 and a first operational amplifier 121. One end of the first switch 11 is electrically connected to an input terminal of the data storage circuit 10, the other end of the first switch 11 is electrically connected to a first terminal of the capacitor unit 13 at a first node N1, a second terminal of the capacitor unit 13 is also electrically connected to a first input terminal of the first operational amplifier 12 at a second node N2, and an output terminal of the first operational amplifier 121 is electrically connected to a third node N3. The second switch 122 is electrically connected between the first node N1 and the third node N3, and the third switch 123 is electrically connected between the second node N2 and the third node N3. The first input terminal of the first operational amplifier 121 is an inverting input terminal, the first operational amplifier 121 includes a second input terminal, and the second input terminal is a non-inverting input terminal and is electrically connected to a reference voltage source Vref1. A reference voltage provided by the reference voltage source is vref1.

In two adjacent sub-pixels P electrically connected to the same data line D, the sub-pixel P in a previous row is the sub-pixel P in an n-th row, the sub-pixel P in a next row is the sub-pixel P in an (n+1)-th row, where n is a positive integer. The first data storage sub-module 101A is configured to control a data signal of the sub-pixel P in the n-th row to be transmitted to the data write module 30, and the second data storage sub-module 101B is configured to control a data signal of the sub-pixel P in the (n+1)-th row to be transmitted to the data write module 30. That is, in the structure as shown in FIG. 5, the first data storage sub-module 101A and the second data storage sub-module 101 B are configured to transmit data signals corresponding to the multiple sub-pixels of the same data line D.

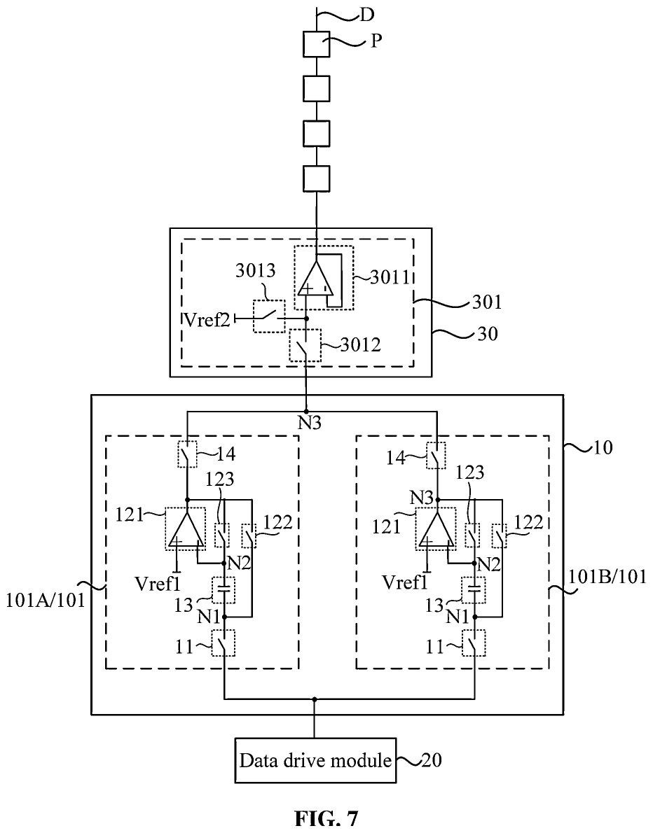

With reference to FIGS. 5 and 6. FIG. 6 is a data driving timing diagram of the silicon-based display panel shown in FIG. 5, and the description is given by using an example in which a turn-on signal of the first switch 11, a turn-on signal of the second switch 122 and a turn-on signal of the third switch 123 are all controlled to be at a high level, and a turn-off signal of the first switch 11, a turn-off signal of the second switch 122 and a turn-off signal of the third switch 123 are all controlled to be at a low level. In the first data storage sub-module 101A, a control signal of the first switch 11 is k1, a control signal of the second switch 122 is k2, and a control signal of the third switch 123 is k3. In the second data storage sub-module 101B, the control signal of the first switch 11 is k1′, the control signal of the second switch 122 is k2′, and the control signal of the third switch 123 is k3′. HS represents a row synchronization signal, and one cycle (such as, a time period T between a t0 moment and a t5 moment) of the row synchronization signal represents the time for scanning one row of sub-pixels; Scan(n) represents an n-th row of scan signal, and Scan (n+1) represents an (n+1)-th row of scan signal. In a case where Scan(n) is at the low level, it represents that an n-th row is being scanned, that is, the sub-pixel P in the n-th row is driven to be turned on, so that the data signal is written into the sub-pixel P in the n-th row.

On the same data line, a data driving process of the sub-pixel P in the n-th row may include a first stage t10_A and a second stage t20_A, and the data storage and transmission are completed by the first data storage sub-module 101A. A data driving process of the sub-pixel Pin the (n+1)-th row may include a first stage t10_B and a second stage t 20_B, and the data storage and transmission are completed by the second data storage sub-module 101B. The second stage t20_A in the data driving process of the sub-pixel P in the n-th row includes the first stage t10_B in the data driving process of the sub-pixel P in the (n+1)-th row.

In a case where the resolution of the display panel is relatively high, the second stage t20 in the data driving process of the sub-pixel P in the n-th row is disposed to overlap with the first stage t10 in the data driving process of the sub-pixel P in the (n+1)-th row, so that the first data storage sub-module 101A transmits the data signal of the sub-pixel P in the n-th row to the data write module 30, and meanwhile the data drive module 20 writes the data signal of the sub-pixel P in the (n+1)-th row into the second data storage sub-module 101B, in this way, the data drive of the silicon-based display panel 100 with a high resolution can be achieved, thereby solving the contradiction between the resolution and the drive time.

For ease of understanding, in conjunction with FIGS. 3 and 6, the first stage t10 of the data driving process of the sub-pixel P overlaps with the first time period T10 of the working process of the data storage sub-module 101, and the second stage t20 of the data driving process of the sub-pixel P overlaps with the second time period T20 of the working process of the data storage sub-module 101. For example, the first stage t10_A of the data driving process of the sub-pixel P in the n-th row overlaps with the first time period T10 of the working process of the first data storage sub-module 101A, and the second stage of time t20_A of the data driving process of the sub-pixel P in the n-th row overlaps with the second time period T20 of the working process of the first data storage sub-module 101A. Similarly, the first stage t10_B of the data driving process of the sub-pixel P in the (n+1)-th row overlaps with the first time period T10 in the working process of the second data storage sub-module 101B, and the second stage t20_B of the data driving process of the sub-pixel P in the (n+1)-th row overlaps with the second time period T20 of the working process of the second data storage sub-module 101B.

With reference to FIG. 6, a detailed description will be given below by using the data driving process of the sub-pixel P in the n-th row as an example.

With reference to FIGS. 5 and 6, in a time period between the to moment and the t1 moment, in the first data storage sub-module 101A, the first switch 11 is turned off, and both the second switch 122 and the third switch 123 are turned on, so that the voltage of the first node N1, the voltage of the second node N2 and the voltage of the third node N3 are equal and are maintained at the first voltage. The voltage of the output terminal of the first operational amplifier 121 is equal to vref1+Vos, that is, the first voltage is the voltage vref1+Vos output by the first operational amplifier 121. At this time, the voltage of the first node N1, the voltage of the second node N2, and the voltage of the third node N3 are all equal and equal to vref1+Vos. The first terminal of the capacitor unit 13 is connected to the first node N1, the second terminal of the capacitor unit 13 is connected to the second node N2, and at this time, the first terminal and the second terminal of the capacitor unit 13 have equal potential and a potential difference of zero. The capacitor unit 13 is initialized, thereby eliminating the influence of the potential difference of the capacitor unit 13 before the t0 moment. The t0 moment to the t1 moment may be an initialization stage of the capacitor unit 13.

In a time period between the t1 moment and a t2 moment, i. e., the first stage t10_A, Scan(n) is in a high level state, the sub-pixel P in the n-th row is not turned on, and the data signal provided by the data drive module 20 may be firstly written into the data storage sub-module 101A configured to transmit the data signal of the sub-pixel P in the n-th row. At this time, both the first switch 11 and the third switch 123 of the first data storage sub-module 101A are turned on, and the second switch 122 is turned off, so that the data signal received by the input terminal IN of the data storage module 10 is written into the first node N1 and is stored in the capacitor unit 13. Moreover, a short circuit is formed between the second node N2 and the third node N3, so that the voltage of the second node N2 and the voltage of the third node N3 are the same and are the first voltage, that is, the voltage of the output terminal of the first operational amplifier 121 is kept to be equal to vref1+Vos.

In a time period between the t2 moment and a t3 moment, both the first switch 11 and the second switch 122 are turned off, and the third switch 123 is turned on, so that the voltage of the second node N2 and the voltage of the third node N3 are maintained at the first voltage, that is, vref1+Vos, and the voltage of the first node N1 is kept to be the voltage of the data signal.

In a time period between the t3 moment and a t4 moment, the first switch 11, the second switch 122, and the third switch 123 are all turned off, so that the voltages of the two terminals of the capacitor unit 13 remain unchanged.

In a time period between the t4 moment and a t5 moment, the second switch 122 is turned on, and the first switch 11 and the third switch 123 are turned off, so that a short circuit is formed between the first node N1 and the third node N3, and further the voltage of the first node N1 is the same as the voltage of the third node N3. The voltage of the first node N1 is the voltage of the written data signal, so that the data signal of the first node N1 is transmitted to the third node N3, that is, the voltage of the third node N3 is also the voltage of the data signal, and the voltage of the second node N2 remains unchanged as vref1+Vos.

In a time period between the t5 moment and a t6 moment, i. e., the second time period t20_A, at this time, the second switch 122 is kept to be turned on, the first switch 11 and the third switch 123 are kept to be turned off, the Scan(n) is in a low level state, the sub-pixel P in the n-th row is turned on, and the first data storage sub-module 101A is configured to transmit the data signal of the third node N3 to the data write module 30, so that the data write module 30 writes the data signal into the data line D electrically connected to the sub-pixel P in the n-th row at this stage, and then the data line D transmits the data signal to the sub-pixel P connected to the data line D in the sub-pixel P in the n-th row.

In this way, the first data storage sub-module 101A may finally transmit the stored data signal to the third node N3 and the data line D stably without being affected by the unregulated voltage of the first operational amplifier 121, so that the stability of the data signal outputted by the first data storage sub-module 101A is improved, and further the data signals finally written into the multiple sub-pixels P are ensured to be consistent, to improve the display uniformity of the silicon-based display panel and the display quality.

Based on the same principle, the driving process of the sub-pixel P in the (n+1)-th row may be referred to the above description, and will not be described in detail here. With continued reference to FIG. 6, in a data driving process of the same sub-pixel P, an ending moment t3 when the third switch 123 is turned on is located before a starting moment t4 when the second switch 122 is turned on.

The third switch 123 is turned on within the first stage t10, to enable the voltage of the second node N2 to be the same as the voltage of the third node N3, thereby preventing the voltage of the first node N1 from deviating under the coupling effect of the capacitor unit 13 due to the voltage fluctuation of the second node N2, and further affecting the stability of the data signal transmitted from the first node N1 to the third node N3 subsequently when the second switch 122 is turned on. Specifically, a fact that the voltage of the first node N1 deviates under the coupling effect of the capacitor unit 13 due to the voltage fluctuation of the second node N2 refers to that, in a case where the second switch 122 is turned on, since the third switch 123 is not turned off yet, a short circuit is formed between the first node N1 and the second node N2, at this time, the voltage of the first node N1, the voltage of the second node N2 and the voltage of the third node N3 are all the same, so that the data signal of the first node N1 and the voltage (i. e., vref1+Vos) output by the first operational amplifier 121 may be overlapped or affect each other. In this case, when the first switch 11 is in a turn-off state, the voltage (i. e. vref1+Vos) output by the first operational amplifier 121 is transmitted to the first node N1. Furthermore, after the third switch 123 is turned off, the voltage of the first node N1 and the voltage of the third node N3 are the same, and are each vref1+Vos, instead of the voltage of the data signal.

With continued reference to FIG. 6, the data driving process of the sub-pixel P further includes a voltage holding stage between the first stage t10 and the second stage t20, i.e., the time period between the t2 moment and the t4 moment. In the time period between the t2 moment and the t3 moment, both the first switch 11 and the second switch 122 are turned off, the third switch 123 is turned on, so that the voltage of the second node N2 and the voltage of the third node N3 are maintained at the first voltage, i.e., vref1+Vos, and the voltage of the first node N1 is kept to be the voltage of the data signal. In the time period between the t3 moment and the t4 moment, the first switch 11, the second switch 122 and the third switch 123 are all turned off, so that the voltages of the two terminals of the capacitor unit 13 further remain unchanged.

In this embodiment, the data write module 30 may include one data write sub-module, and may also include two independent data write sub-modules, which may be set according to practical requirements.

In an optional embodiment, FIG. 7 is a schematic structural diagram of another silicon-based display panel according to an embodiment of the present application. As shown in FIG. 7, the first data storage sub-module 101A and the second data storage sub-module 101B are both electrically connected to the same data write sub-module 301 in the data write module 30 at the third node N3. Each data storage sub-module 101 further includes a fourth switch 14, and the fourth switch 14 is electrically connected between the third node N3 and the output terminal of the first operational amplifier 121. The fourth switch 14 of the first data storage sub-module 101A is configured to be turned on within the second stage of the data driving process of the sub-pixel in the n-th row of the same data line. The fourth switch 14 of the second data storage sub-module 101B is configured to be turned on within the second stage of the data driving process of the sub-pixel P in the (n+1)-th row of the same data line.

Optionally, on the same data line D, in the first stage of the data driving process of the sub-pixel P in the n-th row, when the data drive module 20 writes the data of the sub-pixel P in the n-th row into the first data storage sub-module 101A for storage, at this time, the fourth switch 14 in the first data storage sub-module 101A and the fourth switch 14 in the second data storage sub-module 101 B are turned off, and the first switch 11 in the second data storage sub-module 101B is also turned off. In the second stage of the data driving process of the sub-pixel P in the n-th row, the fourth switch 14 of the first data storage sub-module 101A is turned on to transmit the data signal stored by the first data storage sub-module 101A to the first data write sub-module 301A, so that the first data write sub-module 301A writes the received data signal into the data line and the sub-pixel P in the n-th row.

Similarly, in the first stage of the data driving process of the sub-pixel P in the (n+1)-th row of the same data line, the fourth switch 14 of the second data storage sub-module 101B is turned off, and in the second stage of the data driving process of the sub-pixel P in the (n+1)-th row, the fourth switch 14 of the second data storage sub-module 101B is turned on.

As can be seen from this, each of the first data storage sub-module 101A and the second data storage sub-module 101 B is electrically connected to the same data write sub-module 301, thus the multiple data storage sub-modules 101 need to transmit data signals to the data write sub-module 301 in a time-division manner, in this way, it is necessary to control the fourth switch 14 in the multiple data storage sub-modules 101 to be turned on only in the second stage in which the data storage sub-module 101 needs to transmit the data signal to the data write sub-module 301, thereby avoiding affecting the normal display of the silicon-based display panel due to wrong data signals written into the sub-pixels.

With continued reference to FIG. 7, the data write sub-module 301 includes a second operational amplifier 3011 and a fifth switch 3012. The fifth switch 3011 is connected between the third node N3 and a non-inverting input terminal of the second operational amplifier 3011. An inverting input terminal of the second operational amplifier 3011 is electrically connected to an output terminal of the second operational amplifier 3011. The output terminal of the second operational amplifier 3011 is also electrically connected to the data line D.

The data write sub-module 301 further includes a sixth switch 3013. The sixth switch 3013 is electrically connected between a pre-charging voltage signal terminal Vref2 and the non-inverting input terminal of the second operational amplifier 3011. The sixth switch 3013 is configured to be turned on in a time period from a starting moment of the first stage t10 to an ending moment of the first sub-stage t21, so that a pre-charging voltage signal vref2 of the pre-charging voltage signal terminal Vref2 is provided to the non-inverting input terminal of the second operational amplifier 3011.

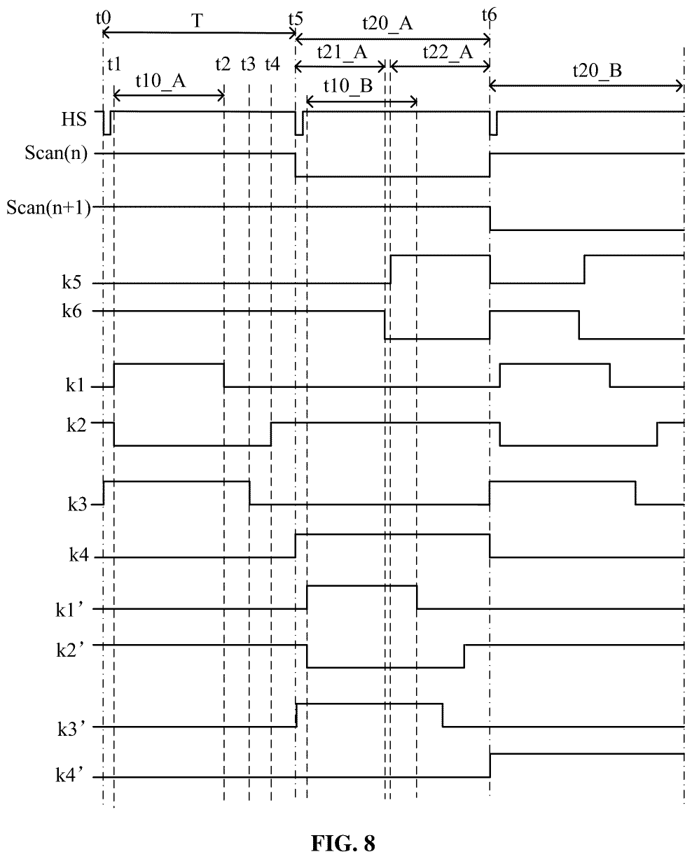

Optionally, with reference to FIGS. 7 and 8, FIG. 8 is a data driving timing diagram of the silicon-based display panel shown in FIG. 7, the second stage t20 of the data driving process of the sub-pixel P includes a first sub-stage t21 and a second sub-stage t22 in succession. The first sub-stage t21 is located between the first sub-stage t10 and the second sub-stage t22. The fifth switch 3012 is configured to be turned off in the first sub-stage t21 and turned on in the second sub-stage t22, to control the signal at the third node N3 to be transmitted to the non-inverting input terminal of the second operational amplifier 3011. In some embodiments, the description is given by using an example in which turn-on signals of the first switch 11, the second switch 122, the third switch 123, the fourth switch 14, the fifth switch 3012 and the sixth switch 3013 are controlled to be at the high level and turn-off signals of the first switch 11, the second switch 122, the third switch 123, the fourth switch 14, the fifth switch 3012 and the sixth switch 3013 are controlled to be at the low level. In the first data storage sub-module 101A, the control signal of the first switch 11 is k1, the control signal of the second switch 122 is k2, the control signal of the third switch 123 is k3, and the control signal of the fourth switch 14 is k4. In the second data storage sub-module 101B, the control signal of the first switch 11 is k1′, the control signal of the second switch 122 is k2′, the control signal of the third switch 123 is k3′, and the control signal of the fourth switch 14 is k4′. In the data write sub-module 301, the control signal of the fifth switch 3012 is k5, and the control signal of the sixth switch 3013 is k6. Scan(n) represents an n-th row of scan signal, and Scan (n+1) represents an (n+1)-th row of scan signal. On the same data line, the data driving process of the sub-pixel P in the n-th row may include the first stage t10_A and the second stage t20_A, and the data storage and transmission are completed by the first data storage sub-module 101A. On the same data line, the data driving process of the sub-pixel P in the (n+1)-th row may include the first stage t10_B and the second stage t20_B, and the data storage and transmission are completed by the second data storage sub-module 101B.

As shown, in some embodiments, the second stage t20_A of the data driving process of the sub-pixel P in the n-th row includes a first sub-phase t21_A and a second sub-stage t22_A in succession, and the fifth switch 3012 is configured to be turned off in the first sub-phase t21_A and turned on in the second sub-stage t22_A. In the first sub-phase t21_A, although the fourth switch 14 of the first data write sub-module 301A is turned on, the signal of the third node N3 in the first data write sub-module 301A cannot be transmitted to the data write sub-module 301. In the second sub-stage t22_A, the fourth switch 14 is still turned on, and the fifth switch 3012 is also turned on, to control the signal of the third node N3 to be transmitted to the non-inverting input terminal of the second operational amplifier 3011. The sixth switch 3013 is configured to be turned on in a time period from a starting moment of the first stage t10_A to an ending moment of the first sub-stage t21_A, so that the pre-charging voltage signal vref2 of the pre-charging voltage signal terminal Vref2 is provided to the non-inverting input terminal of the second operational amplifier 3011. That is, when the signal of the third node N3 is not transmitted to the non-inverting input terminal of the second operational amplifier 3011, the pre-charging voltage signal vref2 is controlled to be provided to the non-inverting input terminal of the second operational amplifier 3011. For other processes, reference may be made to the description in the foregoing other embodiments, and details are not repeatedly described herein.

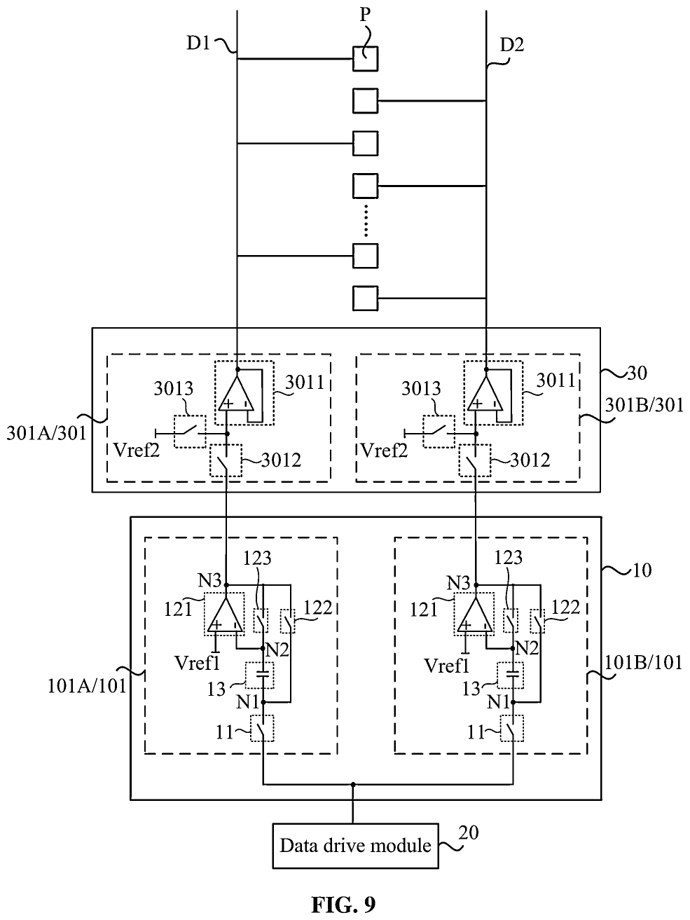

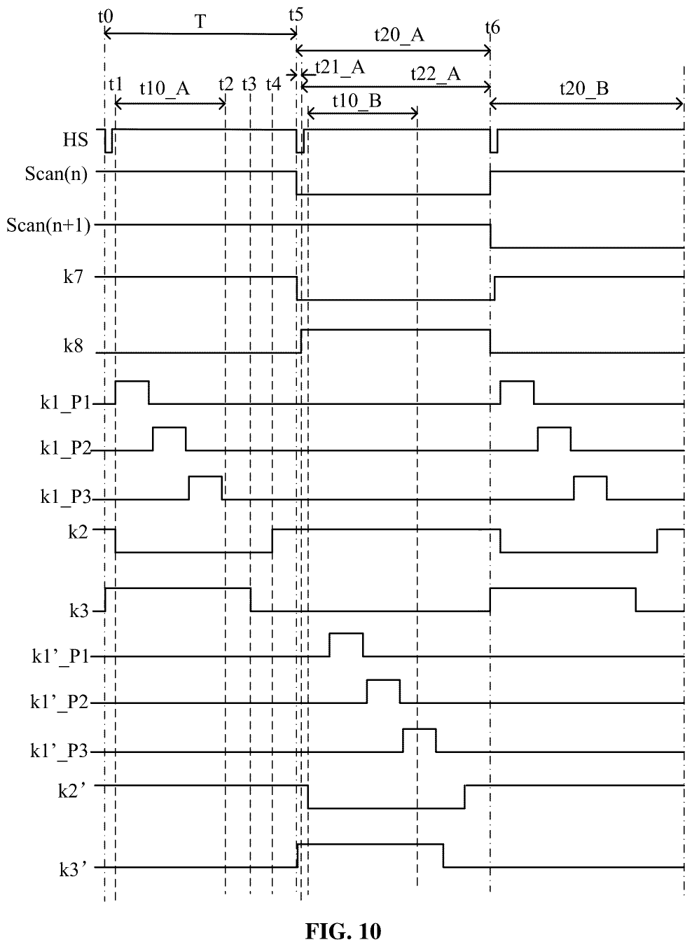

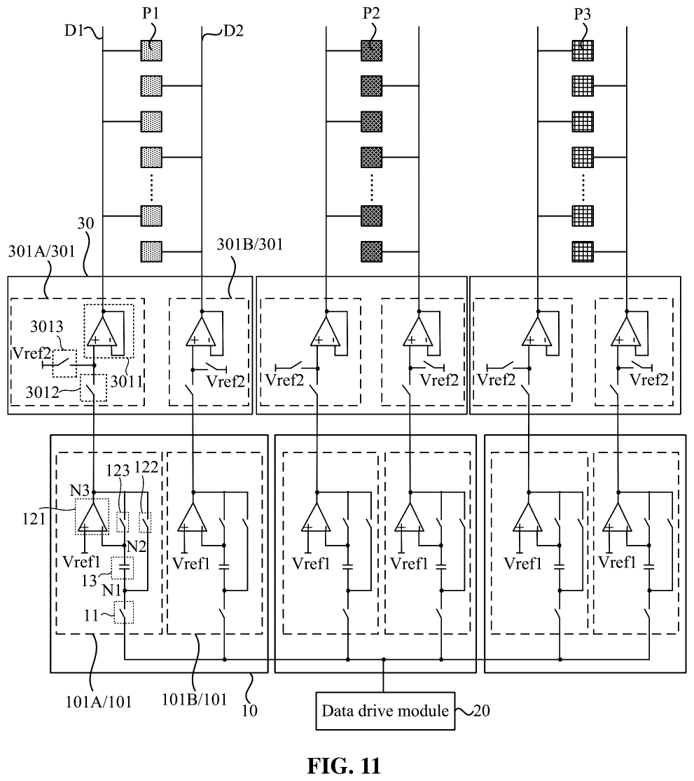

Optionally, FIG. 9 is a schematic structural diagram of another silicon-based display panel according to an embodiment of the present application, and FIG. 10 is a data driving timing diagram of the silicon-based display panel shown in FIG. 9. As shown with combined reference to FIGS. 9 and 10, the data line D includes a first data line D1 and a second data line D2. In the same column of sub-pixels P, sub-pixels P located in odd rows are electrically connected to the first data line D1, and sub-pixels P located in even rows are electrically connected to the second data line D2. The data write module 30 includes two data write sub-modules 301, and the two data write sub-modules 301 are respectively the first data write sub-module 301A and the second data write sub-module 301B. The first data write sub-module 301A is electrically connected to the first data storage sub-module 101A and the first data line D1, separately, and the second data write sub-module 301B is electrically connected to the second data storage sub-module 101B and the second data line D2, separately.

With continued reference to FIG. 9, each of the first data write sub-module 301A and the second data write sub-module 301B includes a second operational amplifier 3011 and a fifth switch 3012. The fifth switch 3011 is electrically connected to the third node N3 and the non-inverting input terminal of the second operational amplifier 3011, separately. The inverting input terminal of the second operational amplifier 3011 is electrically connected to the output terminal of the second operational amplifier 3011. The output terminal of the second operational amplifier 3011 is electrically connected to the data line D. In addition, in the structure shown in FIG. 9, the fourth switch is not disposed in the data storage sub-module 101, either.

Optionally, the data write sub-module 301 further includes a sixth switch 3013. The sixth switch 3013 is electrically connected between the pre-charging voltage signal terminal Vref2 and the non-inverting input terminal of the second operational amplifier 3011. The sixth switch 3013 is configured to be turned on in a time period from a starting moment of the first stage t10 to an ending moment of the first sub-stage t21, so that a pre-charging voltage signal vref2 of the pre-charging voltage signal terminal Vref2 is provided to the non-inverting input terminal of the second operational amplifier 3011.

In some embodiments, an example in which the n-th row is an odd row and the (n+1)-th row is an even row is used, with reference to FIG. 10, the data driving process of the sub-pixel P in the n-th row may include a first stage t10_A and a second stage t20_A, and the data driving process of the sub-pixel P in the (n+1)-th row may include a first stage t10_B and a second stage t20_B.

In the first stage t10_A of the data driving process of the sub-pixel P in the n-th row, the data drive module 20 writes the data of the sub-pixel P in the n-th row into the first data storage sub-module 101A for storage. At this time, a path between the second data storage sub-module 101B and the data drive module 20 is disconnected, that is, the first switch 11 of the second data storage sub-module 101B is turned off, whereby the data drive module 20 is prevented from writing the data of the sub-pixel P in the n-th row into the second data storage sub-module 101B.

In the second stage t20_A of the data driving process of the sub-pixel P in the n-th row, the first data storage sub-module 101A transmits the stored data signal to the first data write sub-module 301A, so that the first data write sub-module 301A writes the received data signal to the first data line D1 and the sub-pixel P in the n-th row. In the second stage t20_A of the data driving process of the sub-pixel P in the n-th row, a path between the first data storage sub-module 101A and the data drive module 20 is disconnected, that is, the first switch 11 of the first data storage sub-module 101A is turned off, and the first switch 11 of the second data storage sub-module 101B is turned on, so that the data drive module 20 writes the data of the sub-pixel P in the (n+1)-th row into the second data storage sub-module 101B for storage. In a case where the scan signal is scanning the sub-pixel P in the (n+2)-th row, the second data storage sub-module 101B transmits the stored data signal to the second data write sub-module 301B, so that the second data write sub-module 301B writes the received data signal into the second data line D2 and the sub-pixel P in the (n+1)-th row. In a case where the scan signal scans the (n+2)-th row, the data drive module 20 rewrites the data of the sub-pixel P in the (n+2)-th row into the first data storage sub-module 101A for storage. At this time, a path between the second data storage sub-module 101B and the data drive module 20 is disconnected, that is, the first switch 11 of the second data storage sub-module 101B is turned off. In this way, data signals may be successively written to the multiple rows of sub-pixels P, to complete the display of one frame of display surface picture, whereby a duration of writing the data signal into the multiple rows of sub-pixels P can be improved, the accuracy of writing the data signal into the sub-pixels P can be ensured, and the display quality can be improved.

With continued reference to FIG. 9 and FIG. 10, the sixth switch 3013 of the first data write sub-module 301A and the fifth switch 3012 of the second data write sub-module 301B may be controlled to be turned on or off by using the same signal k7. The fifth switch 3012 of the first data write sub-module 301A and the sixth switch 3013 of the second data write sub-module 301B may be controlled to be turned on or off by using the same signal k8. In a case where the data drive module 20 stores the data signal to the first data storage sub-module 101A, k7 is at the high level, and k8 is at the low level. Then, in a case where the first data storage sub-module 101A transmits the stored data signal to the first data write sub-module 301A, k7 is at the low level, and k8 is at the high level. The specific driving process is not described herein again, and reference may be made to the above description.

With continued reference to FIG. 8 or FIG. 10, in the same data write sub-module 301, a starting moment when the fifth switch 3012 is turned on is after an ending moment when the sixth switch 3013 is turned off.

Optionally, in a case where the fifth switch 3012 is turned on, the sixth switch 3013 is still in an on state, so that the signal received by the inverting input terminal of the second operational amplifier 3011 is a data signal provided by the data storage sub-module 101 and a voltage signal obtained after the pre-charging voltage signal vref2 of the pre-charging voltage signal terminal Vref2 is superposed, whereby the normal display of the silicon-based display panel is affected due to errors in the data signal finally written into the sub-pixel P. In this way, in a case where the sixth switch 3013 is turned on, it needs to be ensured that the fifth switch 3012 is turned off, and only after the sixth switch 3013 is turned off, the fifth switch 3012 may be turned on, to avoid affecting the accuracy of the data signal written into the sub-pixel P and improve the display effect.

On the basis of any one of the above-described embodiments, optionally, each of the first switch 11, the second switch 122 and the third switch 123 is a metal oxide field effect transistor or other elements, which is not limited herein.

Optionally, the first operational amplifier 121 may be a transconductance first operational amplifier, and the transconductance first operational amplifier has the characteristics of good high-frequency performance, high conversion rate under large signal, simple circuit structure, and low power supply voltage and power consumption, and is easily integrated with other circuits.

The data drive module 20 may be a driver chip or a driver circuit integrated in the silicon-based display panel 100, which is not limited herein. The data driving process of the sub-pixel P may be an entire process in which the data signal is written into the sub-pixel P by sequentially passing through the data drive module 20, the data storage module 10, the data write module 30 and the data line D. In this process, the data storage module 10 may store the data signal provided by the data drive module 20, so that on the one hand, the stability of the data signal written to the data write module 30 may be improved, and on the other hand, in a case where the data storage module 10 includes multiple data storage sub-modules 101, the data drive module 20 can write different data signals to the multiple data storage sub-modules 101 in a short period of time, which is conducive to improving the charging rate of the sub-pixel P and achieving the driving of the silicon-based display panel with the high-resolution.

Optionally, the silicon-based display panel may include multiple data storage modules 10, and the multiple data storage modules 10 are electrically connected to the same data drive module 20. The data drive module 20 is configured to provide data signals of the multiple sub-pixels P in a time-division manner.

In some embodiments, the data drive module 20 is electrically connected to three data storage modules 10 at the same time. The data storage module 10 includes two data storage sub-modules 101, the data write module 30 includes two data write sub-modules, and the data line D electrically connected to the same column of sub-pixels P includes the first data line D1 and the second data line D2. In the same column of sub-pixels P, sub-pixels P in odd rows are electrically connected to the first data line D1, and sub-pixels P in even rows are electrically connected to the second data line D2. The two data storage sub-modules 101 are respectively a first data storage sub-module 101A and a second data storage sub-module 101B. The two data write sub-modules are respectively a first data write sub-module 301A and a second data write sub-module 301B. FIG. 11 is a schematic structural diagram of another silicon-based display panel according to an embodiment of the present application. As shown in FIG. 11, in the three columns of sub-pixels P, each of first column of sub-pixels is a first sub-pixel P1, each of second column of sub-pixels is a second sub-pixel P2, and each of third column of sub-pixels is a third sub-pixel P3.

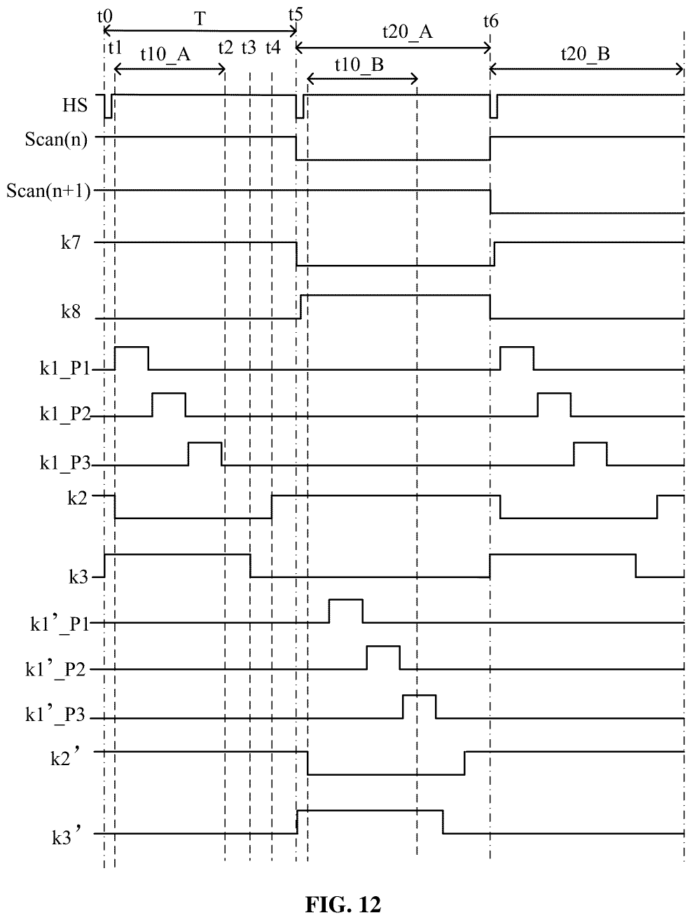

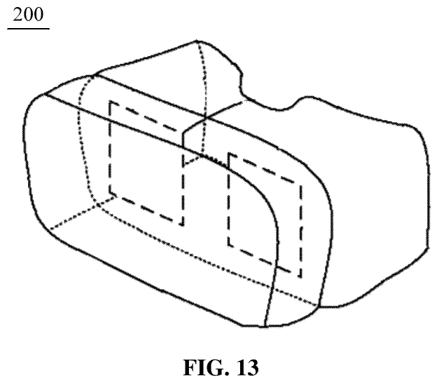

FIG. 12 is a data driving timing diagram of the silicon-based display panel as shown in FIG. 11. As shown with combined reference to FIG. 11 and FIG. 12, the data driving process of the sub-pixel P in the n-th row may include the first stage t10_A and the second stage t20_A, and the data driving process of the sub-pixel P in the (n+1)-th row may include the first stage t10_B and the second stage t20_B. In the first data storage sub-module 101A, the control signal of the first switch 11 is k1, the control signal of the second switch 122 is k2, the control signal of the third switch 123 is k3, and the control signal of the fourth switch 14 is k4. In the second data storage sub-module 101B, the control signal of the first switch 11 is k1′, the control signal of the second switch 122 is k2′, and the control signal of the third switch 123 is k3′. The sixth switch 3013 of the first data write sub-module 301A and the fifth switch 3012 of the second data write sub-module 301B may be controlled to be turned on or off by the same signal k7, and the fifth switch 3012 of the first data write sub-module 301A and the sixth switch 3013 of the second data write sub-module 301B may be controlled to be turned on or off by the same signal k8.

In a case where the n-th row is the odd row, in the first stage t10_A of the data driving process of the sub-pixel P in the n-th row, the first switch 11 of the first data storage sub-module 101A in the multiple data storage modules 10 that separately transmit the data signal to the first sub-pixel P1, the second sub-pixel P2 and the third sub-pixel P is turned on in a time-division manner, that is, the control signals k1_P1, k1_P2, and k1_P3 of the first switch 11 of the multiple first data storage sub-modules 101A are sequentially controlled to be at the high level in a time-division manner. In this case, working states of the second switch 122 and the third switch 123 of the first data storage sub-module 101A in the multiple data storage modules 10 are the same. For a specific working process, reference is made to the foregoing description, and details are not described herein again. Similarly, in the first stage t10_A of the data driving process of the sub-pixel P in the (n+1)-th row, the first switch 11 of the second data storage sub-module 101B in the multiple data storage modules 10 for separately transmitting the data signal to the first sub-pixels P1, the second sub-pixel P2, and the third sub-pixel P is turned on in a time-division manner, that is, the control signals k1′_P1, k1′_P2, and k1′_P3 of the first switch 11 of the multiple first data storage sub-modules 101A are sequentially controlled to be at the high level in a time-division manner. In this case, working states of the second switch 122 and the third switch 123 of the second data storage sub-module 101B in the multiple data storage modules 10 are the same. For a specific working process, reference is made to the foregoing description, and details are not described herein again. In this way, for the silicon-based display panel with the high resolution, the drive speed of the data signal written into the sub-pixel may be accelerated. In addition, the multiple data storage modules 10 are provided so that the same data drive module 20 provides data signals with different data, so that the number of data drive modules 20 can be reduced, thereby simplifying the whole display panel structure, and facilitating not only the design of a narrow border but also reducing the cost.

An embodiment of the present application further provides a display device. FIG. 13 is a schematic structural diagram of a display device according to an embodiment of the present application. As shown in FIG. 13, the display device 200 provided in the embodiment of the present application includes all technical features of the silicon-based display panel provided in the embodiments of the present application, and the effect of the silicon-based display panel provided in the embodiments of the present application can be achieved. For the same, reference may be made to the description of the silicon-based display panel provided in the embodiments of the present application, and details are not described herein again. The display device 200 provided in the embodiments of the present application may be a near-eye display device. The near-eye display device 200 may be a smart glass based on virtual reality (VR) or augmented reality (AR), and is capable of creating a virtual image in a field of view of a single eye or two eyes. By means of the silicon-based display panel placed within a non-sight distance of human eyes, light field information is rendered to the human eyes, so that a virtual scene can be created in front of the human eye. The display device 200 may also be any electronic product that has the display function, including but not limited to a VR product, an AR product, a digital camera, a smart band, smart glasses, a medical device, an industrial control device, a touch interaction terminal and the like, which is not specifically limited in the embodiments of the present application.

1. A data storage circuit, comprising at least one data storage sub-module, wherein a data storage sub-module of the at least one data storage sub-module comprises a first switch, a second switch, a third switch, a capacitor unit and a first operational amplifier; and
wherein one end of the first switch is electrically connected to an input terminal of the data storage circuit, the other end of the first switch is electrically connected to a first terminal of the capacitor unit at a first node, a second terminal of the capacitor unit is electrically connected to a first input terminal of the first operational amplifier at a second node, an output terminal of the first operational amplifier is electrically connected to a third node, the second switch is electrically connected between the first node and the third node, and the third switch is electrically connected between the second node and the third node;
wherein the first input terminal of the first operational amplifier is an inverting input terminal, the first operational amplifier comprises a second input terminal, and the second input terminal is a non-inverting input terminal and electrically connected to a reference voltage source;
wherein a working process of the data storage sub-module comprises a first time period and a second time period;
in the first time period, the first switch and the third switch are turned on, and the second switch is turned off, so that a data signal received by the input terminal of the data storage circuit is controlled to be written into the first node and to be stored in the capacitor unit, and a voltage of the second node is same as a voltage of the third node and is a voltage vref1+Vos of the output terminal of the first operational amplifier, wherein Vos is an unregulated voltage of the first operational amplifier, and vref1 is a reference voltage provided by the reference voltage source; and
in the second time period, the first switch and the third switch are turned off, and the second switch is turned on, so that the voltage of the third node is same as a voltage of the first node and is a voltage of the data signal and effect of the unregulated voltage of the first operational amplifier is eliminated.

2. (canceled)

3. The data storage circuit of claim 1, wherein the working process of the data storage sub-module further comprises a capacitor initialization time period before the first time period, in the capacitor initialization time period, the first switch is turned off, and the second switch and the third switch are turned on, so that a potential of the first node, a potential of the second node and a potential of the third node are equal.

4. (canceled)

5. A silicon-based display panel, comprising a silicon-based substrate, a plurality of sub-pixels arranged in an array and disposed on the silicon-based substrate, and a plurality of data lines, wherein at least part of sub-pixels among the plurality of sub-pixels in a same column are electrically connected to a same data line among the plurality of data lines; and wherein
the silicon-based display panel further comprises a data drive module, a data storage module, and a data write module which are disposed on the silicon-based substrate;
the data drive module is configured to provide data signals corresponding to the plurality of data lines;
the data storage module is configured to store the data signals and control the data signals to be transmitted to the data write module;
the data write module is configured to control the data signals to be written into the plurality of data lines;
the data storage module comprises two data storage sub-modules, the two data storage sub-modules are respectively a first data storage sub-module and a second data storage sub-module, each of the first data storage sub-module and the second data storage sub-module comprise a first switch, a second switch, a third switch, a capacitor unit and a first operational amplifier, one end of the first switch is electrically connected to an input terminal of the data storage module, the other end of the first switch is electrically connected to a first terminal of the capacitor unit at a first node, a second terminal of the capacitor unit is electrically connected to a first input terminal of the first operational amplifier at a second node, an output terminal of the first operational amplifier is electrically connected to a third node, the second switch is electrically connected between the first node and the third node, and the third switch is electrically connected between the second node and the third node; and
in two adjacent rows of sub-pixels electrically connected to a same data line among the plurality of data lines, a sub-pixel in a previous row is a sub-pixel in an n-th row, a sub-pixel in a next row is a sub-pixel in an (n+1)-th row, where n is a positive integer; and the first data storage sub-module is configured to control a data signal of the sub-pixel in the n-th row to be transmitted to the data write module, and the second data storage sub-module is configured to control a data signal of the sub-pixel in the (n+1)-th row to be transmitted to the data write module;
wherein the first input terminal of the first operational amplifier is an inverting input terminal, the first operational amplifier comprises a second input terminal, and the second input terminal is a non-inverting input terminal and is electrically connected to a reference voltage source;
wherein a data driving process of the plurality of sub-pixels comprises a first stage and a second stage;
in the first stage, the first switch and the third switch are turned on, and the second switch is turned off, so that a data signal received by the input terminal of the data storage module is controlled to be written into the first node and to be stored in the capacitor unit, and a voltage of the second node is same as a voltage of the third node, is a first voltage and is also a voltage vref1+Vos of the output terminal of the first operational amplifier, wherein Vos is an unregulated voltage of the first operational amplifier, and vref1 is a reference voltage provided by the reference voltage source;
in the second stage, the first switch and the third switch are turned off, and the second switch is turned on, so that the voltage of the third node is same as a voltage of the first node and is a voltage of the data signal and effect of the unregulated voltage of the first operational amplifier is eliminated; and
wherein the second stage in a data driving process of the sub-pixel in the n-th row comprises the first stage in a data driving process of the sub-pixel in the (n+1)-th row.

6. (canceled)

7. The silicon-based display panel of claim 5, wherein the data driving process of the plurality of sub-pixels further comprises an initialization stage before the first stage, in the initialization stage, the first switch is turned off, the second switch and the third switch are turned on, and a potential of the first node, a potential of the second node and a potential of the third node are equal.

8. (canceled)

9. The silicon-based display panel of claim 5, wherein in a data driving process of a same sub-pixel among the plurality of sub-pixels, a termination moment in which the third switch is turned on is before an initiation moment in which the second switch is turned on.

10. The silicon-based display panel of claim 5, wherein the data driving process of the plurality of sub-pixels further comprises a voltage maintaining stage located between the first stage and the second stage; and
within the voltage maintaining stage, the voltage of the second node and the voltage of the third node are maintained at the first voltage, and the capacitor unit is configured to maintain the voltage of the first node to be a voltage of the data signal within the voltage maintaining stage.

11. The silicon-based display panel of claim 5, wherein a data line of the plurality of data lines comprises a first data line and a second data line, in a same column of sub-pixels among the plurality of sub-pixels, sub-pixels in odd rows are electrically connected to the first data line, and sub-pixels in even rows are electrically connected to the second data line;
the data write module comprises two data write sub-modules, and the two data write sub-modules are a first data write sub-module and a second data write sub-module, respectively; and
the first data write sub-module is electrically connected to the first data storage sub-module and the first data line, separately, and the second data write sub-module is electrically connected to the second data storage sub-module and the second data line, separately.

12. The silicon-based display panel of claim 5, wherein the first data storage sub-module and the second data storage sub-module are electrically connected to a same data write sub-module among the plurality of data write sub-modules in the data write module at the third node;
each of the two data storage sub-modules further comprises a fourth switch, and the fourth switch is electrically connected between the third node and the output terminal of the first operational amplifier;
the fourth switch of the first data storage sub-module is configured to be turned on in the second stage of the data driving process of the sub-pixel in the n-th row; and
the fourth switch of the second data storage sub-module is configured to be turned on in the second stage of the data driving process of the sub-pixel in the (n+1)-th row.

13. The silicon-based display panel of claim 11, wherein the data write sub-module comprises a second operational amplifier and a fifth switch;
the fifth switch is electrically connected to the third node and a non-inverting input terminal of the second operational amplifier, separately, an inverting input terminal of the second operational amplifier is electrically connected to an output terminal of the second operational amplifier, and the output terminal of the second operational amplifier is electrically connected to a corresponding data line of the plurality of data lines;
the second stage comprises a first sub-stage and a second sub-stage in succession, and the first sub-stage is located between the first stage and the second sub-stage; and
the fifth switch is configured to be turned off in the first sub-stage and turned on in the second sub-stage to control a signal of the third node to be transmitted to the non-inverting input terminal of the second operational amplifier.

14. The silicon-based display panel of claim 13, wherein the data write sub-module further comprises a sixth switch;
the sixth switch is electrically connected between a pre-charge voltage signal terminal and the non-inverting input terminal of the second operational amplifier; and
the sixth switch is configured to be turned on during a time period between a starting moment of the first stage and a termination moment of the first sub-stage, so that a pre-charge voltage signal of the pre-charge voltage signal terminal is provided to the non-inverting input terminal of the second operational amplifier.

15. The silicon-based display panel of claim 14, wherein in the same data write sub-module, a starting moment when the fifth switch is turned on is after a termination moment when the sixth switch is turned off.

16. The silicon-based display panel of claim 5, comprising a plurality of data storage modules, and the plurality of data storage modules are electrically connected to a same data drive module, and the data drive module is configured to provide data signals of the plurality of sub-pixels in a time-division manner.

17. A display device, comprising a silicon-based display panel wherein the silicon-based display panel comprises a silicon-based substrate, a plurality of sub-pixels arranged in an array and disposed on the silicon-based substrate, and a plurality of data lines, wherein at least part of sub-pixels among the plurality of sub-pixels in a same column are electrically connected to a same data line among the plurality of data lines; and wherein
the silicon-based display panel further comprises a data drive module, a data storage module, and a data write module which are disposed on the silicon-based substrate;
the data drive module is configured to provide data signals corresponding to the plurality of data lines;
the data storage module is configured to store the data signals and control the data signals to be transmitted to the data write module;
the data write module is configured to control the data signals to be written into the plurality of data lines;
the data storage module comprises two data storage sub-modules, the two data storage sub-modules are respectively a first data storage sub-module and a second data storage sub-module, each of the first data storage sub-module and the second data storage sub-module comprise a first switch, a second switch, a third switch, a capacitor unit and a first operational amplifier, one end of the first switch is electrically connected to an input terminal of the data storage module, the other end of the first switch is electrically connected to a first terminal of the capacitor unit at a first node, a second terminal of the capacitor unit is electrically connected to a first input terminal of the first operational amplifier at a second node, an output terminal of the first operational amplifier is electrically connected to a third node, the second switch is electrically connected between the first node and the third node, and the third switch is electrically connected between the second node and the third node; and
in two adjacent rows of sub-pixels electrically connected to a same data line among the plurality of data lines, a sub-pixel in a previous row is a sub-pixel in an n-th row, a sub-pixel in a next row is a sub-pixel in an (n+1)-th row, where n is a positive integer; and the first data storage sub-module is configured to control a data signal of the sub-pixel in the n-th row to be transmitted to the data write module, and the second data storage sub-module is configured to control a data signal of the sub-pixel in the (n+1)-th row to be transmitted to the data write module;
wherein the first input terminal of the first operational amplifier is an inverting input terminal, the first operational amplifier comprises a second input terminal, and the second input terminal is a non-inverting input terminal and is electrically connected to a reference voltage source;
wherein a data driving process of the plurality of sub-pixels comprises a first stage and a second stage;
in the first stage, the first switch and the third switch are turned on, and the second switch is turned off, so that a data signal received by the input terminal of the data storage module is controlled to be written into the first node and to be stored in the capacitor unit, and a voltage of the second node is same as a voltage of the third node, is a first voltage and is also a voltage vref1+Vos of the output terminal of the first operational amplifier, wherein Vos is an unregulated voltage of the first operational amplifier, and vref1 is a reference voltage provided by the reference voltage source;
in the second stage, the first switch and the third switch are turned off, and the second switch is turned on, so that the voltage of the third node is same as a voltage of the first node and is a voltage of the data signal and effect of the unregulated voltage of the first operational amplifier is eliminated; and
wherein the second stage in a data driving process of the sub-pixel in the n-th row comprises the first stage in a data driving process of the sub-pixel in the (n+1)-th row.

18. The silicon-based display panel of claim 12, wherein the data write sub-module comprises a second operational amplifier and a fifth switch;
the fifth switch is electrically connected to the third node and a non-inverting input terminal of the second operational amplifier, separately, an inverting input terminal of the second operational amplifier is electrically connected to an output terminal of the second operational amplifier, and the output terminal of the second operational amplifier is electrically connected to a corresponding data line of the plurality of data lines;
the second stage comprises a first sub-stage and a second sub-stage in succession, and the first sub-stage is located between the first stage and the second sub-stage; and
the fifth switch is configured to be turned off in the first sub-stage and turned on in the second sub-stage to control a signal of the third node to be transmitted to the non-inverting input terminal of the second operational amplifier.

19. The device of claim 17, wherein the data driving process of the plurality of sub-pixels further comprises an initialization stage before the first stage, in the initialization stage, the first switch is turned off, the second switch and the third switch are turned on, and a potential of the first node, a potential of the second node and a potential of the third node are equal.

20. The device of claim 17, wherein in a data driving process of a same sub-pixel among the plurality of sub-pixels, a termination moment in which the third switch is turned on is before an initiation moment in which the second switch is turned on.

21. The device of claim 17, wherein the data driving process of the plurality of sub-pixels further comprises a voltage maintaining stage located between the first stage and the second stage; and
within the voltage maintaining stage, the voltage of the second node and the voltage of the third node are maintained at the first voltage, and the capacitor unit is configured to maintain the voltage of the first node to be a voltage of the data signal within the voltage maintaining stage.

22. The device of claim 17, wherein a data line of the plurality of data lines comprises a first data line and a second data line, in a same column of sub-pixels among the plurality of sub-pixels, sub-pixels in odd rows are electrically connected to the first data line, and sub-pixels in even rows are electrically connected to the second data line;
the data write module comprises two data write sub-modules, and the two data write sub-modules are a first data write sub-module and a second data write sub-module, respectively; and
the first data write sub-module is electrically connected to the first data storage sub-module and the first data line, separately, and the second data write sub-module is electrically connected to the second data storage sub-module and the second data line, separately.

23. The device of claim 17, wherein the first data storage sub-module and the second data storage sub-module are electrically connected to a same data write sub-module among the plurality of data write sub-modules in the data write module at the third node;
each of the two data storage sub-modules further comprises a fourth switch, and the fourth switch is electrically connected between the third node and the output terminal of the first operational amplifier;
the fourth switch of the first data storage sub-module is configured to be turned on in the second stage of the data driving process of the sub-pixel in the n-th row; and
the fourth switch of the second data storage sub-module is configured to be turned on in the second stage of the data driving process of the sub-pixel in the (n+1)-th row.

24. The device of claim 22, wherein the data write sub-module comprises a second operational amplifier and a fifth switch;
the fifth switch is electrically connected to the third node and a non-inverting input terminal of the second operational amplifier, separately, an inverting input terminal of the second operational amplifier is electrically connected to an output terminal of the second operational amplifier, and the output terminal of the second operational amplifier is electrically connected to a corresponding data line of the plurality of data lines;
the second stage comprises a first sub-stage and a second sub-stage in succession, and the first sub-stage is located between the first stage and the second sub-stage; and
the fifth switch is configured to be turned off in the first sub-stage and turned on in the second sub-stage to control a signal of the third node to be transmitted to the non-inverting input terminal of the second operational amplifier.
